(19) United States
(12) Patent Application Publication
(10) Pub. No.: US 2025/0317015 A1
(43) Pub. Date: Oct. 9, 2025

(54) ELECTROMAGNETIC ROTATING POWER MACHINE

(71) Applicant: MAKISOLU G. K., Chiba (JP)

(72) Inventor: Koichiro MAKI, Chiba (JP)

(73) Assignee: MAKISOLU G. K., Chiba (JP)

(21) Appl. No.: 19/242,071

(22) Filed: Jun. 18, 2025

Related U.S. Application Data
(63) Continuation of application No. PCT/JP2023/041899, filed on Nov. 21, 2023.

(30) Foreign Application Priority Data
Dec. 20, 2022 (JP) 2022-203280

(51) Int. Cl. H02K 1/24

(52) U.S. Cl. CPC H02K 1/24

(57) ABSTRACT

An electromagnetic rotating power machine has at least one rotary shaft, a rotor, and a stator. The electromagnetic rotating power machine includes a spatial region between the rotor and the stator where electromagnetic repulsion or electromagnetic attraction acts. The spatial region includes at least two regions of different rotational symmetry. At least one soft or hard magnetic material is incorporated into each of the rotor and the stator. Magnetic pole surfaces, which are pair-polarized to N and S poles in the magnetic material, of the rotor and the stator are arranged in the regions of different rotational symmetry.

### CROSS-REFERENCE TO RELATED APPLICATIONS

This is a continuation of International Application No. PCT/JP2023/041899 filed on Nov. 21, 2023, and claims priority from Japanese Patent Application No. 2022-203280 filed on Dec. 20, 2022, the entire content of which is incorporated herein by reference.

### TECHNICAL FIELD

The present invention relates to an electromagnetic rotating power machine.

### BACKGROUND ART

Electromagnetic rotating power machines (hereinafter also referred to as motors) of the related art are classified into magnet rotating types in which a permanent magnet rotates, and electromagnetic coil rotating types (or brush types) in which an electromagnet rotates. In both cases, a gap is provided between an electromagnetic coil and a permanent magnet, and an electromagnetic force produced in the gap is controlled to achieve the rotation mechanism. An electromagnet includes a coil wound to magnetize a magnetic core (core) made of materials such as an electromagnetic steel sheet using an electric current. Here, “magnetize” means aligning the magnetic moments of the core in one direction. A permanent magnet has magnetization oriented in one direction inside the material, even without receiving a magnetic field from outside, and it causes magnetic charge to seep through the surface of the material where the magnetization disappears. Here, “magnetization” is a property of a permanent magnet and refers to the sum of the magnetic moments inside the permanent magnet. Further, a permanent magnet has a demagnetization property in which the magnetization is weakened by an internal demagnetizing field due to its shape anisotropy. In both permanent magnets and electromagnets, an electromagnetic rotating mechanism is configured by interposing an electromagnetic force-generating gap between a pair of a rotating rotor (rotor) or a fixed stator (stator).

Examples of the gap that generates an electromagnetic force are a radial type and an axial type. In the former, the gap formed by the rotor and the stator has a cylindrical shape with a magnetic line of force oriented in the radial direction. In the latter, the gap formed by the rotor and the stator has a disk-like shape with a magnetic line of force oriented in the axial direction. In both of the motors described above, the poles of the permanent magnets facing the gap are characterized by alternating N and S poles, as described in JP2022-114002A. The phenomenon in which the poles overlap at the same position as the poles of the permanent magnet due to the rotation of the motor is defined as rotational symmetry, and positions of the poles of the magnet that generate the magnetic field in the gap, which is the important field for magnetic action or the distribution of the magnetic charge seeped through a magnetic material as an extension of the poles of the magnet are called positions of rotational symmetry.

One ring-shaped space formed by the positions of rotational symmetry and the gap that is the field for magnetic interaction is defined as a rotationally symmetric region. Further, the ring-shaped space is sometimes called a gap space. A permanent magnet is sometimes referred to as a magnet, simply.

Further, in a motor with a magnet arrangement of n poles, half of that number, i.e., n/2, are formed as N-S pole pairs. In order to create the maximum magnetic field on the same circumference, most of such motors require a complex arrangement in which a curved magnetic circuit connecting the N and S poles is combined with a soft magnetic material such as a high-permeability electromagnetic steel sheet or a permanent magnet (for example, the Halbach arrangement shown in JP2022-121861A and JP2022-170963A).

When an N-pole and an S-pole are placed on the same circumference, their positions overlap due to rotation, so that they are at the same rotationally symmetric position.

In contrast to the general-purpose permanent magnet arrangements described above, a method has been proposed of arranging only the N-pole side of the permanent magnets in a rotationally symmetric region, which is called a consequent type, such as exemplified in JP7070316B (JP2020-065349A). According to the method, the N-poles protrude from the surface of a high-permeability magnetic material core, but the S-poles are buried inside the core, so that the magnetic line of force penetrate into the surface of the high-permeability magnetic material between the N-poles of the permanent magnets, generates the S-poles, whose position is in the same rotationally symmetric region as the N-poles, resulting in a state in which the magnetic charges of the N and S poles are distributed and arranged alternately, similar to the form of the permanent magnet arrangement of the general-purpose motor described above.

Further, JP4644832B proposes a consequent type arrangement in which single poles such as the N-pole of a permanent magnet are arranged in a rotationally symmetric region. However, this relates to a bearingless rotating machine and is not used in a mechanism that electromagnetically produces a rotational force.

### SUMMARY OF INVENTION

However, in the configuration of JP2022-114002A, the N and S poles of the permanent magnets used in the motor are paired and arranged alternately in the direction of rotation, and thus the length of a magnetic circuit formed by the paired poles decreases as the number of poles increases. As a result, the shape anisotropy weakens the magnetization that is the source of the permanent magnet as a field magnet, and in addition, it weakens the magnetic interaction with the opposing electromagnet in the electromagnetic force action gap.

In a case where the magnet arrangement is made complex in order to strengthen the field magnet, as in the configuration of JP2022-121861A, the volume required to implement the structure increases, which limits further multi-polarization for smooth rotation. Alternatively, it hinders an increase in volume of each component that generates the electromagnetic energies (magnet, high-permeability core, high coil current) in order to aim for higher output.

In electromagnets often used in stators, it is not necessary to match the number of poles with the permanent magnet, but in order to achieve high performance, a considerable number of poles is necessary. Regarding coils of electromagnets, a method called a concentrated winding in which a coil is placed on every tooth of a magnetic material that forms the magnetic core (core) requires having the volume of the coil and the volume of the magnetic material teeth that form the magnetic core. Achieving multiple poles involves a process of manufacturing a microstructure, and there are technical limitations.

A distributed type used for three-phase current control involves a complicated winding process in order to wind the wire across the teeth of the magnetic core for several poles.

Further, another example of distinctive magnet arrangement is a hybrid (sometimes abbreviated as HB) type stepping motor. This is achieved by incorporating a two-pole permanent magnet inside the rotor in order to alternate many teeth on the rotor between the N and S poles, dividing it into N-pole and S-pole regions, and thus achieving finely polarized teeth. However, because some of the N-poles and some of the S-poles belong to the same magnetic pole region of the electromagnet on the stator side, a mechanism to control rotation with a pulse signal is achieved, but it has never been applied to power motors of the related art.

Brush motors in which permanent magnets are placed on the stator side are also widely used. Although such a motor can achieve sufficient shape magnetic anisotropy in the wide external region where the stator is located, it requires a mechanical contact mechanism that mainly uses conductive metal brushes to supply current to the rotating electromagnet.

In light of the issues described above, an object of the invention is to provide a motor structure in which a simple magnetic circuit for permanent magnets can be designed and the number of windings of electromagnetic coils can be significantly reduced. Another object of the invention is to devise a motor with a new and more complex configuration by simplifying the magnetic circuit for permanent magnets and the windings of electromagnetic coils.

According to a first invention, an electromagnetic rotating power machine with at least one rotary shaft includes a spatial region between a rotor and a stator where electromagnetic repulsion or electromagnetic attraction acts, in which the spatial region has at least two regions of different rotational symmetry, at least one magnetically soft or hard magnetic material is incorporated into each of the rotor and the stator, and magnetic pole surfaces pair-polarized to N and S poles in the magnetic material are located in the regions of different rotational symmetry.

According to a second invention, in the electromagnetic rotating power machine of the first invention, an electromagnetic type coil is fixed to the stator, and the coil polarizes at least a part of the rotor as an electromagnet into N and S poles.

According to a third invention, an electromagnetic rotating motor with at least one rotary shaft includes a so-called rotor and stator, and any one of the rotor and the stator is a permanent magnet and the other is an electromagnet. In a spatial region of an axial or radial gap where electromagnetic repulsion or attraction acts between the two, one or more surface regions of any one of materials of a permanent magnet and an electromagnetic steel sheet, which exhibits one pole characteristic with rotational symmetry on the permanent magnet side, have rotational symmetry different from one or more surface regions of any material exhibiting the other pole characteristic with rotational symmetry, or one magnetic pole and the other magnetic pole due to a magnetic flux emitted from one electromagnet have different rotational symmetry.

Here, a surface region with polar characteristics is a region where the magnetic charge of the N-pole or S-pole seeps out at the boundary between the magnetic material and the gap space. The surface regions with polar characteristics having different rotational symmetry means that a surface portion of a part of the magnetic material from which the magnetic charge of the N-pole seeps out rotates and moves in a spatial region different from that of the surface portion of the S-pole. Hereinafter, in the invention, the phenomenon of magnetic charge seeping out is also expressed as magnetization of magnetic charge, similar to the representation of electrification of electric charge in electromagnetism. In general, magnetization means magnetizing, and the generation of a magnetic field by magnetization M is completely equivalent to the generation of a magnetic field by magnetic charge on the surface of a magnetic material, and the only difference therebetween is a representation.

The term “gap space” used in the invention includes the following spaces.

There is a space where the surfaces of magnetic materials that carry magnetic charges, such as electromagnet yokes and the ends of permanent magnets, match or shift due to the rotational symmetry of a finite integer with respect to the rotation phase of the rotor, and magnetic materials and non-magnetic materials such as air are located temporally. The part whose shape changes depending on the rotation phase is included in the region meant by “gap space”.

Similarly, although the stator is fixed, the surface of the magnetic material magnetized by the magnetic charge belonging to the stator can be considered to rotate when viewed from the rotating coordinate system of the rotating rotor, and there are parts whose shape changes depending on the rotation phase also on the stator side. In particular, in calculating the time average of electromagnetic repulsion or attraction, the region that can be the range of influence of the main action is included in the “gap space”.

Therefore, the term “gap space” is used herein to represent a region with rotational symmetry that includes the surface that carries magnetic charges of all electromagnet yokes and permanent magnets located on the rotor and the stator, and the vicinity thereof. It forms a so-called ring-shaped uniform rotating body. In the invention, this gap space is present in at least two places, and they are regions with different symmetry.

In permanent magnet rotors of the related art in which the N and S poles are arranged alternately in the same shape with the same rotational radius, they are located at the same rotationally symmetric position and both poles rotate and move through the same spatial region and, it can be thus expressed that the surface regions with pole characteristics have the same rotationally symmetric regions.

The term “electromagnetic rotating power machine” is used, as the functional expression, to represent a power machine that rotates electromagnetically, and the term “electromagnetic rotating motor” is also used, which has the exact same meaning.

The arrangement of the permanent magnets forming the electromagnetic rotating motor of the invention and the structure thereof enable simplification of the structure of the electromagnetic coil, which achieves a significant reduction in manufacturing costs.

### BRIEF DESCRIPTION OF DRAWINGS

Exemplary embodiment(s) of the present invention will be described in detail based on the following figures, wherein:

FIG. 1A is a cross-sectional view of an element formed by a pair of an N-pole and an S-pole that are present at different rotational symmetric positions and an electromagnetic coil, for explaining an example of an axially arranged radial gap motor according to the invention;

FIG. 1B is a cross-sectional view of an element formed by a pair of an N-pole and an S-pole that are present at different rotational symmetric positions and an electromagnetic coil, for explaining an example of a radially arranged axial gap motor according to the invention;

FIG. 2 illustrates winding forms according to the invention, and are conceptual diagrams of a concentrated winding and a full winding that allows for generating the same magnetic field as that for the concentrated winding;

FIG. 3A is a diagram of an electromagnet part for explaining a concentrated winding on a magnetic core of an axially arranged radial gap motor in a related-art example and an example of the invention;

FIG. 3B is a diagram of an electromagnet part for explaining a full winding on a magnetic core of an axially arranged radial gap motor that is made possible in an example of the invention, and a diagram of an assembly example thereof;

FIG. 4A is a diagram of an assembly example for explaining a concentrated winding on a magnetic core of a radially arranged axial gap motor that is made possible in an example of the invention;

FIG. 4B is a diagram of an assembly example for explaining a full winding on a magnetic core of a radially arranged axial gap motor that is made possible in an example of the invention;

FIG. 5A is a representative diagram illustrating the arrangement of magnets and other magnetic materials of an axially arranged radial gap motor of the invention;

FIG. 5B is an example of a form in which axially arranged radial gap motors are combined in two stages made possible in an example of the invention;

FIG. 6 is a diagram in which the number of poles on the S-pole side is changed by a magnetic material in the magnet arrangement of an axially arranged radial gap motor of the invention;

FIG. 7 is a diagram in which a permanent magnet is a stator and an electromagnet is a rotor in a radially arranged motor that is made possible in an example of the invention;

FIG. 8 is a diagram illustrating two combinations of a rotor and a stator and two combinations of an axial gap and a radial gap using the position of a rotary shaft in a form in which a permanent magnet is extended by a yoke;

FIG. 9A is a diagram of a rotor using the permanent magnet illustrated in FIG. 1A;

FIG. 9B is a diagram in which the permanent magnet illustrated in a of FIG. 9A is changed to an electromagnet and an excitation coil is fixed;

FIG. 10A is a diagram of a rotor using the permanent magnet illustrated in FIG. 1B;

FIG. 10B is a diagram in which the permanent magnet illustrated in FIG. 10A is changed to an electromagnet and a fixed excitation coil is embedded in the center of the rotor;

FIG. 10C is a diagram in which the permanent magnet illustrated in FIG. 10A is changed to an electromagnet and a fixed excitation coil is inserted from the side of the rotor;

FIG. 10D is a diagram of a fixed high-permeability magnetic material incorporated inside the fixed excitation coil illustrated in FIG. 10B;

FIG. 11A is a three-dimensional illustration of FIG. 10B;

FIG. 11B is a diagram in which the fixed excitation coil in the three-dimensional illustration of FIG. 10D has a concentrated winding; and

FIG. 11C is a diagram in which the fixed excitation coil in the three-dimensional illustration of FIG. 10D has a full winding.

### DESCRIPTION OF EMBODIMENTS

An electromagnetic rotating power machine according to embodiments of the invention will be described with reference to the drawings. The embodiments described below are merely an example, and there is another configuration other than the following embodiments. First, a description is given of the third invention.

Rotating motors using permanent magnets and electromagnets come in two types of a radial gap type and an axial gap type according to the shape of a spatial gap where the paired elements exert the electromagnetic effects, and therefore, each of the two types is described in the present embodiment. The electromagnetic type refers to a type in which a current passes through a coil inside a rotating power machine, and a magnetic field generated is used to produce a magnetic force in the gap. From this perspective, a magnetic force is also expressed as an electromagnetic force.

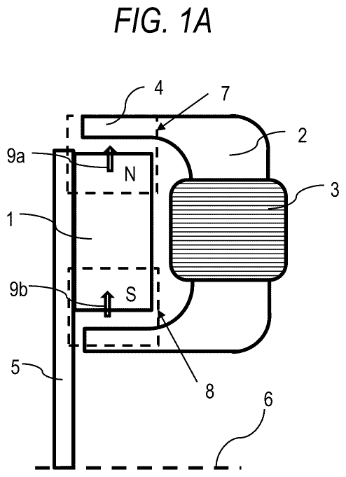

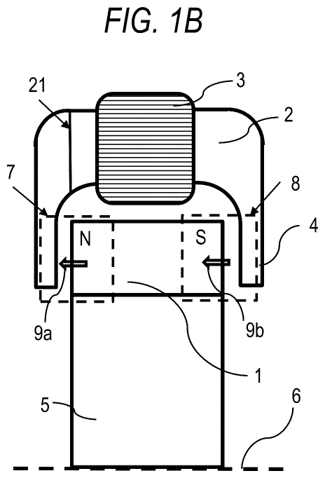

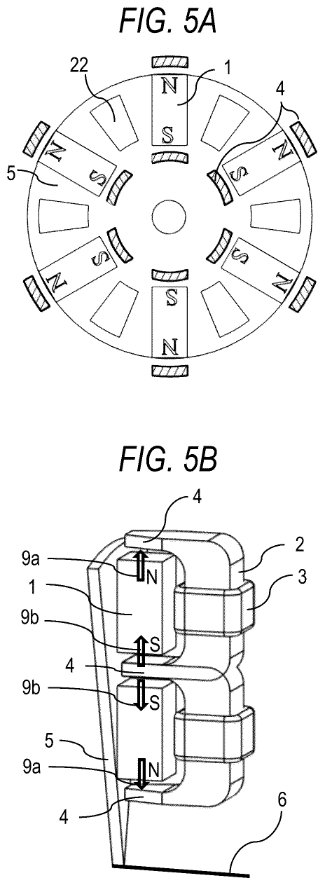

FIG. 1A illustrates the configuration of a radial gap type rotating motor, although a rotor and a stator are disposed in the axial direction. In a related-art motor in which the N and S poles alternate in rotationally symmetric positions, a permanent magnet and an electromagnet are disposed in the axial direction, which is classified as an axial gap type. However, in the example illustrated in FIG. 1A, which is one form of the invention, teeth 4 on the extension of a yoke of the electromagnet is such that the N and S poles of the electromagnet generated at a certain moment extend in opposite directions, so that the largest electromagnetic force is generated in rotationally symmetric regions (gaps) 7 and 8 where the permanent magnet acts, and vector directions 9a and 9b of this force are in the radial direction, which is a characteristic of an axially arranged radial gap type. One form of the invention is a configuration in which the multiple magnets 1 having this structure are collected and disposed in a rotationally symmetric arrangement, including the polarity, as illustrated in FIG. 5A. However, the polarity of the electromagnet 2 does not prevent the N and S poles from being changed depending on the direction of the current.

FIG. 1B illustrates a form of a rotating motor with a radially arranged axial gap configuration. As with FIG. 1A, the largest electromagnetic force is produced in rotationally symmetric regions (gaps) 7 and 8 where the permanent magnets act, the vector directions 9a and 9b of this force are in the axial direction, which is a characteristic of the axial gap type although the rotor and the stator are arranged radially.

In both of the two configurations described above, the rotationally symmetric region where the N-pole is located is different from the rotationally symmetric region where the S-pole is located. For simplicity of explanation, herein, a cylindrical coordinate system is used in which a rotary shaft of the motor is set to the z direction and the radial direction is set to the r direction. Then, each gap space is cylindrical with a magnetization vector in the r direction in the radial gap type, and is disk-shaped with a magnetization vector in the z direction in the axial gap type. In addition, the different rotationally symmetric positions mean that their radii r are different in the radial gap type and their z values are different in the axial gap type.

The difference between the different values (for example, in the radial gap type, the absolute value of the difference between the radius where the N-pole is located and the radius where the S-pole is located, and, in the axial gap type, the absolute value of the difference between the axial coordinate where the N-pole is located and the axial coordinate where the S-pole is located) is the minimum length L of the permanent magnet. In the embodiment, the length can be changed according to the demagnetization characteristics of the permanent magnet, and it is unnecessary to make an improvement or take an approach such as configuring a complex magnetic circuit to compensate for the magnetization characteristics of the permanent magnet. The relationship between the length L of the permanent magnet and the magnetization characteristics of the permanent magnet is due to the shape anisotropy of the permanent magnet. When the length L is short, the N-pole and the S-pole are close to each other, and therefore, the magnetization of the permanent magnet is reduced (demagnetization) due to the reverse magnetic field (demagnetizing field) generated inside the permanent magnet, which is a dependency on the hysteresis curve represented by the magnetization of the permanent magnet.

It can therefore be understood that the invention, which enables the length L to be selected, offers the possibility of a new motor structure that maximizes the characteristics of permanent magnets.

In the two form examples described above, a permanent magnet is used as the rotor and an electromagnet is used as the stator; however, it is possible to use an electromagnet as the rotor and use a permanent magnet as the stator by adding a current transmission mechanism such as a brush.

Further, although the examples of radial gap type and axial gap type are described above, when the teeth 4 at ends of a U-shaped magnetic material are shortened, a direction 9 of the magnetization vector is gradually inclined accordingly, and at a certain length, the radial gap type and the axial gap type are reversed in the definitions thereof. Thus, both cases have a possibility that they can be a hybrid that has the properties of both the radial gap and the axial gap. Accordingly, in order to distinguish between the two types, it is necessary to focus on the arrangement direction of the electromagnet and the permanent magnet and characterize them by whether they are located in different radial positions or different axial positions.

In light of the above, in a case where the positional relationship between the magnet and the electromagnetic coil is in the axial direction as in FIG. 1A, it is referred to as an axial arrangement, and in a case where the positional relationship therebetween is in the radial direction as in FIG. 1B, it is referred to as a radial arrangement. This allows structures that are conceptually close to the related-art names to be associated.

Next, the description is given of the versatility of windings and the resulting possibilities for developing new motors according to a form of the invention.

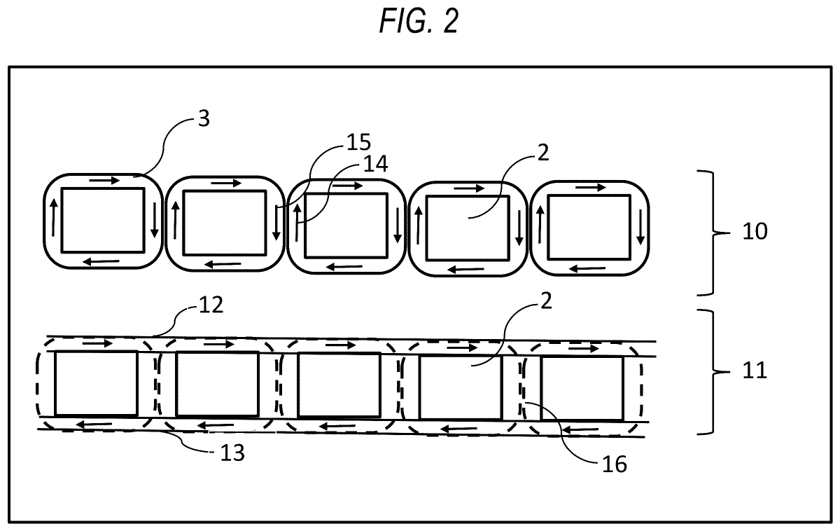

In the form of the invention illustrated in FIGS. 1A and 1B, electromagnets are prepared whose number is the same as the number of the teeth 4 that receive a magnetic force from the permanent magnet, as with the structure of a normal motor. However, in the invention in which the same-polarized pole is arranged in the same rotationally symmetric region, all the teeth may have the same pole. Therefore, as illustrated in FIG. 2, currents flowing through coils (concentrated winding) 10 wound around each electromagnet to generate the same magnetic poles on all the teeth have the same direction of rotation, which is a state in which currents 14 and 15 between two magnetic cores cancel each other out, and is equivalent to a state 11 of a new winding (full winding) arrangement in which an outer current coil 12 and an inner current coil 13 are interposed. A so-called distributed winding is a method of incorporating coils around several teeth, but the distributed winding for all the teeth can be regarded as the full winding here. However, it is difficult to significantly increase the volume of the magnetic core like the full winding, even with the distributed winding applied to a partial magnetic core.

In a case where the magnet arrangement in FIG. 1B goes around the rotary shaft to separate the N and S poles to the left and right at the central cross section of the rotary shaft, the arrangement of the permanent magnets on the rotor is the same as that of an HB type stepping motor. However, in an HB type stepping motor, the N and S poles on the permanent magnet side receive magnetic forces from the same poles generated by the same coil on the electromagnet side, so that the N and S poles cancel each other out as magnetic forces within the same coil, and it can be said that they are in the same symmetric region, not different symmetric regions. A feature of the invention is that the regions to receive the magnetic force are different regions on the N-pole side and the S-pole side of a single magnetic material.

This eliminates the need for a coil 16 between the magnetic cores, which is present in a state 10, so that high-permeability core materials to be used for the magnetic cores can be further increased.

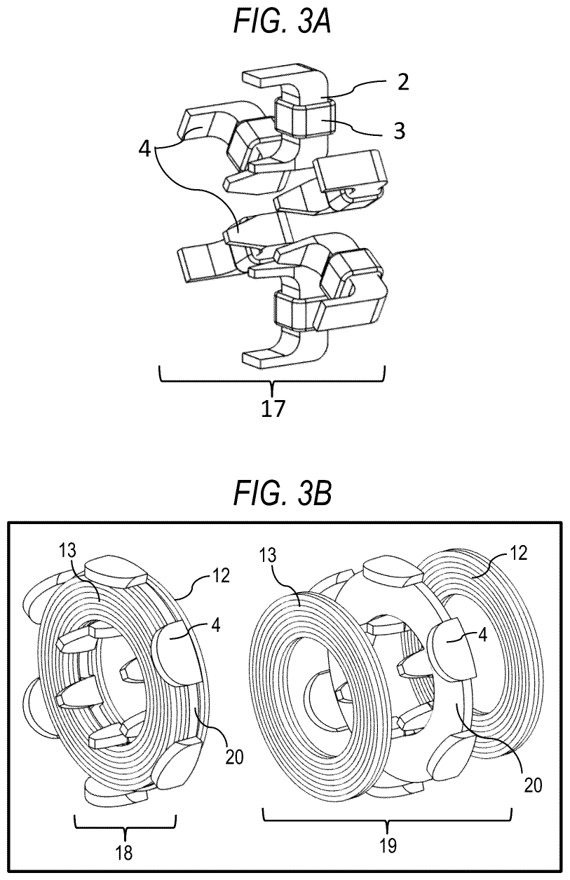

Further, a description is provided explaining how this makes assembly easy with reference to the drawings. FIG. 3A illustrates a three-dimensional diagram of the electromagnet part only, which corresponds to the state 10. A yoke 2 wound with a coil 3 and a tooth 4 at an end thereof make a set, and a manufacturing process is required to combine them for the number of teeth.

In contrast, in the state 11, no matter how many poles there are, the coils required are the outer current coil 12 and the inner current coil 13. FIG. 3B illustrates the configuration. A magnetic core 2 as a whole forms a single disk 20, and yoke ends 4 protrude into the gap in accordance with the number of teeth. As a result, while the number of teeth matches the number of coils in the concentrated winding, any number of teeth can be used and attached to a magnetic core disk 20 in the full winding. For example, the number of teeth on the N-pole side and the number of teeth on the S-pole side may be different.

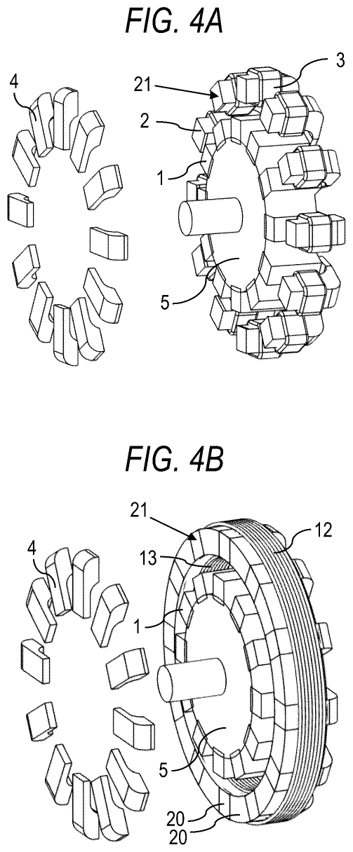

FIG. 4A illustrates an example of assembling a concentrated winding structure for a motor with a radially arranged axial gap configuration. The yoke end teeth 4 are divided at a joint surface 21, the rotor is assembled into the stator, and then the yoke ends are joined.

In contrast, FIG. 4B illustrates an example of assembling a full winding structure for a motor with a radially arranged axial gap configuration. All that is required is to incorporate the magnetic core disk 20 between the outer current coil 12 and the inner current coil 13, and the entire space surrounded by the coils can be filled with a magnetic core with high magnetic permeability.

A description is given of an example of how stacking the new electromagnet structures can lead to new motors with added functions.

The axially arranged coil illustrated in FIG. 3B includes the inner current coil 13 and the outer current coil 12. The inner current coil 13 and the outer current coil 12 are defined as a first coil and a second coil, respectively, and the disk 20 of the magnetic core assembly is defined as a first magnetic core disk, and thereby, it is possible to consider a structure in which they are repeatedly stacked and add a second magnetic core disk, a third coil, a third magnetic core disk, a fourth coil, and so on. A controlled current is supplied into each of the coils to cause magnetization of different phases, and individual yoke end teeth are provided for them to protrude into a range of influence of the magnetic force of a permanent magnet, which achieves a function equivalent to, for example, a three-phase current motor.

Next, a description is mainly given of a possible embodiment of the invention for a rotor incorporating a permanent magnet therein. The invention has a feature of arranging only the same-polarized magnetic pole in a rotationally symmetric region, and as illustrated in FIG. 5A, a high-permeability magnetic material 22 may be disposed between adjacent permanent magnets, and a mechanism may be provided which adjusts the spatial distribution of the magnetic field strength between the magnetic poles in the rotationally symmetric region. FIG. 5A illustrates a state in which the surface of the magnetic material 22 is different from the radius at which the N-pole continuing from the permanent magnet is located. In a case where the magnetic material 22 extends and the surface thereof reaches the same radius as each pole of the permanent magnet, even when the high-permeability magnetic material 22 has a magnetic pole opposite to the adjacent magnetic poles on the same radius, in a case where the main electromagnetic rotational force generating gaps of the S-pole and the N-pole of the permanent magnet are located at different radii as illustrated in FIG. 5A, they can be regarded as gap spaces of different rotationally symmetry. Any form for the secondary magnetic charge distribution such as the magnetic material, except for the magnetic charge distribution of the main N and S poles, does not deviate from the scope of the invention. As described in JP7070316B (JP2020-065349A), in a case where all the magnetic flux continuing from the N-pole connects to the S-pole of the same radius, the N-pole and the S-pole have the same amount of magnetic charge distribution and fall into the category of rotational symmetry, which is the form of the related-art technology that is a problem to be solved by the invention.

Further, with regard to the permanent magnets used in the invention, multiple ones of the invention may be used as illustrated in FIG. 5B to form a magnetic circuit with an arrangement that is easy to implement. In this case, the electromagnets may be either a concentrated winding or a full winding.

In the invention, the magnetic charge distribution that determines the pole type of the rotationally symmetric region includes not only the permanent magnets but also the high-permeability magnetic materials. This is achieved by attaching a yoke for a permanent magnet to a permanent magnet, spatially extending the magnetic charge distribution of the permanent magnet, and the continuum of magnetization vectors connecting the extended N and S poles can be regarded as a “deemed permanent magnet.” Therefore, the description of the embodiment using the permanent magnet described above can be used in the same way when a yoke is attached.

A description is given of an embodiment of the invention in which a high-permeability magnetic material such as an electromagnetic steel sheet is attached to an end of a permanent magnet.

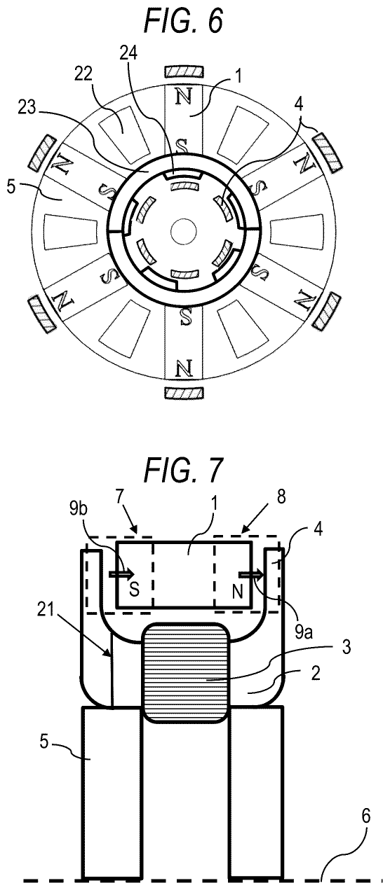

FIG. 6 according to an embodiment of the invention illustrates that the number of magnetic poles in the gap can be changed by collecting magnetic charges of magnetic poles of some permanent magnets in one yoke 23 and providing the end of the yoke with the protrusions 24 whose number is different from that of permanent magnets because the same magnetic pole type is present in the same rotationally symmetric region. This makes it possible, for example, to construct the N-pole as a structure with 6-fold rotational symmetry but construct the S-pole 5-fold rotational symmetry.

Next, FIG. 7 illustrates a case where the rotor is an electromagnet and the stator is a permanent magnet. In FIG. 7, the electromagnet as a concentrated winding is illustrated, but the electromagnet may be a full winding as illustrated in FIG. 4B.

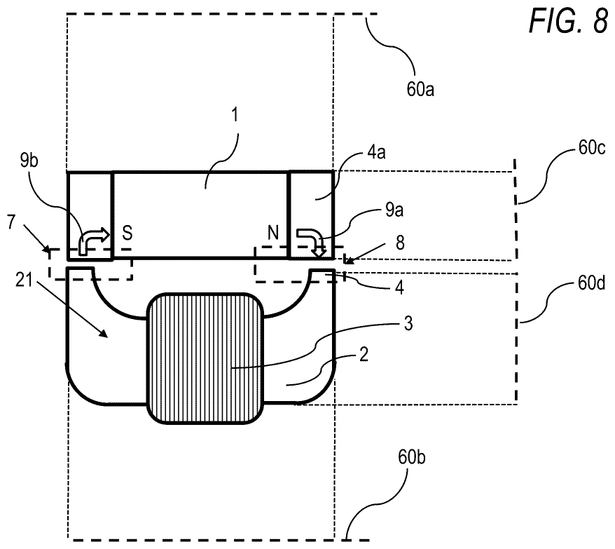

Using the high-permeability magnetic material 23 for collecting the magnetic charge of the permanent magnet and the high-permeability magnetic material 24 for redistributing the magnetic charge of the permanent magnet illustrated in FIG. 6 can configure a related-art radial gap type motor with yokes attached to both ends of the permanent magnet illustrated in FIG. 8. In this case also, the rotationally symmetric region of the N-pole and the rotationally symmetric region of the S-pole are different.

Further, in FIG. 8, rotary shafts 60a, 60b, 60c, and 60d are illustrated to indicate which element of the permanent magnet 1 and the electromagnet 2 is used as the rotor. Since there are two options for the direction of rotation, i.e., radial and axial, there are four combinations of rotary shaft positions depending on the number of elements and the number of directions of rotation. The rotary shaft 60a is for a case where the permanent magnet is the rotor and is of the radial gap type. The rotary shaft 60b is for a case where the electromagnet is the rotor and is of the radial gap type. The rotary shaft 60c is for a case where the permanent magnet is the rotor and is of the axial gap type. The rotary shaft 60d is for a case where the electromagnet is the rotor and is of the axial gap type. In the form of the extended permanent magnet using the yoke, the axial arrangement is the axial gap type and the radial arrangement is the radial gap type, which is consistent with the names of a general-purpose motor.

The coil 3 wound around the electromagnet 2 illustrated in FIG. 8 is an example of the concentrated winding, but it may be replaced with the full winding.

In the embodiment regarding the symmetric regions of the poles of the permanent magnet described above, the same poles are located in the same rotationally symmetric region. Next, a description is given of another embodiment in which the invention can be achieved even when both poles are mixedly arranged in two rotationally symmetric regions, that is, “one magnetic pole and the other magnetic pole due to the magnetic flux emitted from one electromagnet have different rotational symmetry”.

FIG. 8 illustrates a combination of a permanent magnet and an electromagnet that exhibits rotational symmetry. A configuration in which the multiple combinations are arranged around the rotary shaft, with the magnetic poles of the permanent magnets arranged alternately or arbitrarily is also one embodiment of the invention because the N-pole and the S-pole of one electromagnet are located in different rotationally symmetric regions. “Alternately arranged permanent magnets with respect to the rotary shaft” means that the N-pole and the S-pole of the magnet in FIG. 8 are reversed when the rotation angle is changed and the structures are positioned so as to overlap, taking symmetry into consideration. “Arbitrarily arranged permanent magnets” means that the order of the poles that appear in the first rotationally symmetric region 7 is any order, and, in a case where the first half are N-poles and the rest are S-poles, it is the same as a two-pole motor. However, in the second rotationally symmetric region 8, a pole opposite to those of the first rotationally symmetric region 7 appear. Therefore, the embodiment achieves the features of the invention from the perspective of the electromagnet, and can be expressed as having rotational symmetry in which one magnetic pole is different from the other magnetic pole due to the magnetic flux emitted from one electromagnet.

As is apparent from the embodiments described above, in the invention, the same poles are present in the same rotationally symmetric region; however, it does not mean that only one of them is operated, and magnetic flux leakage is reduced to effectively act on both the N and S poles of the magnet. Further, the electromagnet yoke end 4, which distributes the magnetic charge of the N or S pole determined depending on the direction of the current flowing through the coil of each electromagnet, is present in the rotationally symmetric region on the electromagnet side, and therefore, unlike the permanent magnet side, the type of pole on the electromagnet side is not specified.

Next, the first invention will be described.

FIG. 8 illustrates a combination of a rotor and a stator according to the third invention. Materials of the magnetic materials that make up electromagnets and permanent magnets used in the diagram are not different from those used in electromagnetic rotating power machines of the related art. However, a unique feature is that, pair polarization in one magnetic material divides the magnetic material surface on which the magnetizing magnetic charges are distributed into the N and S poles, leading to the two gap spaces 7 and 8 that are regions where electromagnetic repulsion and attraction act.

The pair polarization originates from the residual magnetization of an electromagnetic coil or a permanent magnet, and is a common expression for magnetizing magnetically soft and hard magnetic materials, such as electromagnets and permanent magnets, with an electromagnetic coil. Magnetically soft magnetic materials, also called soft magnetic materials, are ferromagnetic materials with high magnetic permeability and high saturation magnetization, such as electromagnetic steel sheets, which exhibit strong magnetization with electromagnetic type coils. Polarizing or magnetizing a magnetic material with a coil is sometimes called excitation. An electromagnetic coil refers to a coil that fulfills this role, and an electromagnetic type coil also refers to an electromagnetic coil. The term “excitation coil” is intended to emphasize that an electromagnetic coil has a role of magnetizing a magnetic material. Magnetically hard magnetic materials, also called hard magnetic materials, refer to permanent magnets (permanent magnets).

In the first invention, the permanent magnet (magnetically hard magnetic material) used in the third invention is expressed as a function of a magnetic material, and is a higher-level concept that also includes an electromagnet. The function of the magnetic material required for the invention is to form the pair polarization to the N and S poles on the surface of the magnetic material, and the method for the pair polarization may be any of methods known in the related art. Methods for the pair polarization include applying a magnetic field to the magnetic material using an excitation coil, and placing a permanent magnet in a magnetic circuit made by the magnetic material and magnetizing it by allowing the magnetic line of force emitted by the permanent magnet to penetrate into the magnetic material. The form in which a soft magnetic material 4a is pair-polarized by a permanent magnet is the “deemed permanent magnet” described above.

According to a feature of the first invention, an electromagnetic rotating power machine with at least one rotary shaft includes a spatial region between a rotor and a stator where electromagnetic repulsion or electromagnetic attraction acts, in which the spatial region has at least two regions of different rotational symmetry, at least one magnetically soft or hard magnetic material is incorporated into each of the rotor and the stator, and magnetic pole surfaces pair-polarized to N and S poles in the magnetic material are located in the regions of different rotational symmetry.

In a case where both the rotor and the stator are made of magnetically soft magnetic materials, this means that both are connected to the ends of electromagnets or permanent magnets so that the lines of magnetic force are continuous as magnetic flux lines. In a case where both the rotor and the stator are magnetically hard magnetic materials, this means that both are permanent magnets, but at least one of the permanent magnets is equipped with an excitation coil, and the maximum magnetic field generated by the excitation coil exceeds the coercive force of that one permanent magnet, which allows the magnetization of the magnetic material to be changed and adjusted as desired. In general, a soft magnetic material has large saturation magnetization; however, the value of the coercive force is small compared to the range of variation of the magnetic field applied from the outside. From this perspective, even for magnetic materials classified as magnetically hard magnetic materials because their coercive force is relatively large, the magnetization of the magnetically hard magnetic material can also be changed within a range of variation of the magnetic field that is sufficiently larger than the coercive force.

Further, by improving the composition and the heat treatment process during the manufacturing process of permanent magnets, it is possible to create permanent magnets whose hysteresis curves (physical property curves representing the change in magnetization or magnetic flux density of a magnetic material due to a change in magnetic field, also called magnetization-magnetic field curves or magnetic flux density-magnetic field curves) are not simple rectangular, but have a curve that includes a multi-stage demagnetization process. It is also possible to change the magnetization of the magnetic material by applying a minor loop magnetic field to the multi-stage magnetization curve with an excitation coil. In view of the embodiments using such a variety of magnetically hard magnetic materials, even with a magnetically hard magnetic material, it is possible to change the magnetic charge on the surface of the magnetic material in the rotationally symmetric region and to control the electromagnetic attraction and repulsion in the region.

In a case where one of the rotor and the stator is made of a magnetically soft magnetic material and the other is made of a magnetically hard magnetic material, it becomes a well-known electric rotating power machine using permanent magnets.

Next, a description is given of the characteristic that within the magnetic material, the magnetic pole surface pair-polarized to the N and S poles are located in rotationally symmetric regions different from each other.

The physical interpretation of the pair-polarized N and S poles is that the magnetic flux lines, which are continuous in the opposite directions at the original source that causes the pair polarization, are emitted as a magnetic field into the gap space as the magnetization disappears on the surface of the magnetic material, and a magnetic charge distribution of the N and S poles occurs on that surface. The invention is that the N and S poles are located in different rotationally symmetric regions, and may be in the same rotationally symmetric region as poles generated from different magnetic flux line sources. The determination as to whether they originate from the same source can be achieved through numerical simulations such as magnetic field analysis. This is possible because magnetic flux lines (which have a distribution similar to that of magnetic lines of force in non-magnetic materials) in regions of high magnetic flux density form a closed loop, and it depends on whether the closed loop of the magnetic flux lines is connected to the magnetic charges of the N and S poles on the surface through which the closed loop of the magnetic flux lines passes. The magnetic flux lines that form the closed loop herein refer to the main magnetic flux emitted from the source, and the relationship between the N and S poles connected by the magnetic lines of force to the extent that they are considered to be leakage can be ignored. The extent regarded as leakage refers to the surface magnetic charge distribution that is not planned as the main purpose.

Next, the second invention will be described.

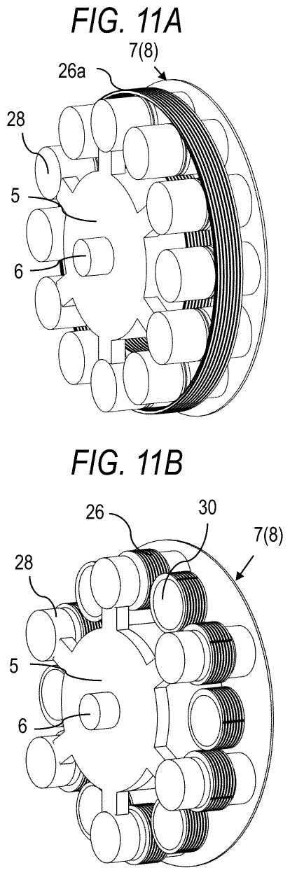

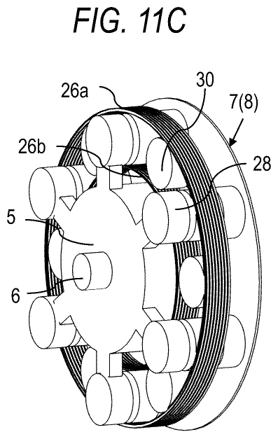

In the embodiments of the invention described above, the permanent magnet used as the rotor may be an electromagnet with a coil wound around a soft magnetic material such as an electromagnetic steel sheet. FIG. 8 illustrates an embodiment in which the permanent magnet when 60a represents a rotating magnet is the rotor. The polarization of the N and S poles can be achieved by the full winding as illustrated in FIG. 4B, and the coil with a full winding does not need to rotate together with the soft magnetic material and can be fixed like a stator. Further, in a case where the magnetic material is also divided, a coil with a concentrated winding can be fixed to the stator as illustrated in a three-dimensional diagram of FIG. 11B.

The second invention is therefore the electromagnetic rotating power machine according to the first invention, in which an electromagnetic type coil is fixed to the stator, and the coil polarizes at least a part of the rotor as an electromagnet into the N and S poles. The magnetic material used for the rotor is excited by the current in the coil, it is only required that there is an increment in magnetization due to the excitation, and it may be a magnetic material with residual magnetization or a magnetic material belonging to the classification of magnetically hard magnetic materials.

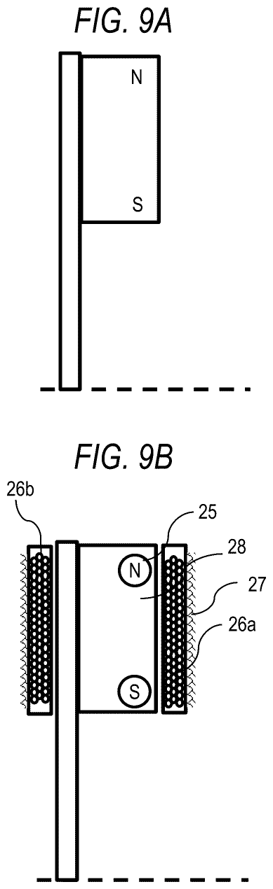

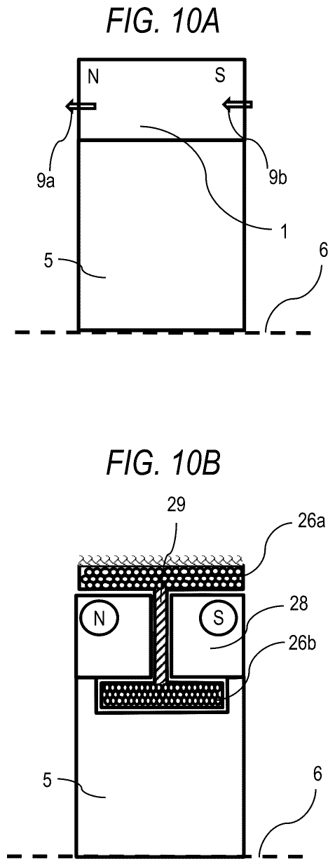

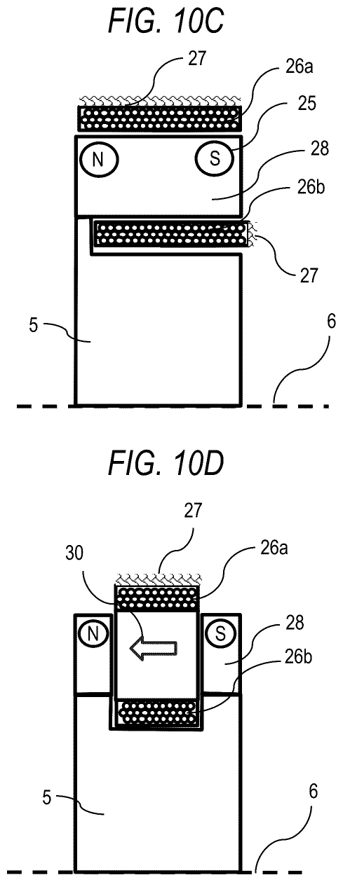

Examples of structures that achieve the above are illustrated in FIGS. 9A, 9B, 10A, 10B and 10C. Both FIG. 9A and FIG. 10A illustrate the rotor part used with the permanent magnets of FIG. 1A and FIG. 1B. FIGS. 9B, 10B and 10C illustrate the permanent magnets replaced with electromagnets that have the same magnetic pole (magnetic charge) distribution.

FIG. 9B illustrates a structure in which a magnetic material 28 is magnetized by fixed coils installed on the left and right sides of the rotor. FIG. 10B illustrates a structure in which the magnetic material 28 of the rotor is separated into two, with a connecting part inserted therebetween to connect the external and internal coils. Current is routed at the connecting part, and the magnetic material is magnetized by the magnetic field created by the two coils 26a and 26b, resulting in the same magnetic charge distribution as that of the permanent magnet illustrated in FIGS. 9A and 10A. FIG. 10C illustrates a structure in which two coils are fixed on the left and right, respectively, which allows the magnetic material 28 to be magnetized and enables a non-rotating function. FIG. 10D illustrates a structure in which a high-permeability magnetic material 30 is fixed inside a fixed excitation coil, and the magnetic material 28 of the rotor is magnetized through the magnetization of the high-permeability magnetic material 30.

A three-dimensional embodiment representation of FIG. 10B is illustrated in FIG. 11A. There are two three-dimensional embodiment representations of FIG. 10D, illustrated in FIGS. 11B and 11C. FIG. 11B is an electromagnet with a concentrated winding structure 26 for a fixed magnetic material 30, and FIG. 11C is an electromagnet in which multiple magnetic materials 30 are incorporated into fixed full windings 26a and 26b. In both FIGS. 11B and 11C, the magnetic materials 28 of the rotor on both sides are magnetized through the high-permeability magnetic material 30. Further outside, the gap space 7 or 8 is located.

The magnetic materials illustrated in FIGS. 9B, 10B and 10C are not uniform rotating bodies. In a case where FIGS. 9A and 10A illustrate a multi-pole structure with permanent magnets arranged in the direction of rotation, the magnetic materials are arranged to generate the same number of magnetic poles, or the same number of yokes are attached to the magnetic material of the uniform rotating body.

The magnetic material for rotor may also be a composite of a soft magnetic material and a hard magnetic material (permanent magnet), and a fixed magnetic material may be provided between the magnetic material for rotor and a fixed electromagnetic type coil to connect the magnetic circuit.

In a configuration in which the permanent magnet on the rotor side of an HB type stepping motor is replaced with the electromagnet according to the second invention, the N-pole and the S-pole are still present in the same rotationally symmetric region, and therefore this is not included in any of the inventions that require the existence of two different rotationally symmetric regions according to the first invention.

The invention has the characteristic of facilitating the manufacturing process while having the same performance as motors of the related art, and therefore, the invention can be used in many fields where motors are extensively utilized.

The invention enables simplifying the winding coil and, thus, it can be applied to various motors for electric vehicles where multi-polarization increases the manufacturing costs, and in combination with electromagnets replacing permanent magnets, the invention can be applied to electric appliances such as motors for driving electric vehicles that require high speed rotation and high torque.

Further, since it increases the shape anisotropy of the magnet, the same torque can be achieved with a smaller number of magnets, which makes the invention highly useful in all motors that use expensive rare earth elements.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electromagnetic rotating power machine comprising:
at least one rotary shaft;
a rotor; and
a stator, wherein
a soft or hard magnetic material is incorporated into each of the rotor and the stator, the magnetic material constituting an electromagnet or a permanent magnet,
the soft magnetic material is configured from one or more soft magnetic materials, and the hard magnetic material is configured from two or more hard magnetic materials which are arranged in rotational symmetry and maintained to be in noncontact with each other,
all the magnetic materials, which are an excited electromagnet or a permanent magnet provided with the rotor and the stator, are pair-polarized to N and S poles therein,
magnetic pole surfaces appearing magnetic charge of the N and S poles are provided with the rotor and the stator,
electromagnetic repulsion or electromagnetic attraction acts in a spatial region formed such that the magnetic pole surfaces of the rotor and the stator face each other via a gap during rotation of the rotor,
the spatial region is a region with rotational symmetry and includes at least two regions of different rotational symmetry,
a magnetic pole surface appearing an N pole and a magnetic pole surface appearing an S pole, which are pair-polarized in one magnetic material disposed in the stator, face a different spatial region, respectively,
a magnetic pole surface appearing an N pole and a magnetic pole surface appearing an S pole, which are pair-polarized in one magnetic material disposed in the rotor, face at least any one of the spatial regions on which the magnetic pole surfaces of the stator face, to move according to the rotation of the rotor, and
one of the magnetic pole surfaces of the rotor and one of the magnetic pole surfaces of the stator, which are in an identical spatial region, are arranged to have a same-polarized pole.

2. The electromagnetic rotating power machine according to claim 1, wherein
electromagnets are used for the rotor and the stator,
the rotor has an electromagnet in which an excitation coil is arranged with a soft magnetic material,
the magnetic pole surfaces, which are polarized to an N pole and an S pole, of the rotor move over the two different spatial regions according to the rotation of the rotor,
the rotor is provided with the electromagnet having the magnetic material and the excitation coil in which the magnetic pole surfaces of the N pole and the S pole are pair-polarized in the magnetic material, and
the excitation coil is fixed to the stator, or the magnetic material is fixed inside the excitation coil fixed to the stator.

3. An electromagnetic rotating power machine comprising:
at least one rotary shaft;
a rotor; and
a stator, wherein
a soft or hard magnetic material is incorporated into each of the rotor and the stator, the magnetic material constituting an electromagnet or a permanent magnet,
the soft magnetic material is configured from one or more soft magnetic materials, and the hard magnetic material is configured from two or more hard magnetic materials which are arranged in rotational symmetry and maintained to be in noncontact with each other,
all the magnetic materials, which are an excited electromagnet or a permanent magnet provided with the rotor and the stator, are pair-polarized to N and S poles therein,
magnetic pole surfaces appearing magnetic charge of the N and S poles are provided with the rotor and the stator,
electromagnetic repulsion or electromagnetic attraction acts in a spatial region formed such that the magnetic pole surfaces of the rotor and the stator face each other via a gap during rotation of the rotor,
the spatial region is a region with rotational symmetry and includes at least two regions of different rotational symmetry,
a magnetic pole surface appearing an N pole and a magnetic pole surface appearing an S pole, which are pair-polarized in one magnetic material disposed in the stator, face a different spatial region, respectively,
a magnetic pole surface appearing an N pole and a magnetic pole surface appearing an S pole, which are pair-polarized in one magnetic material disposed in the rotor, face at least any one of the spatial regions on which the magnetic pole surfaces of the stator face, to move according to the rotation of the rotor, and
one of the magnetic pole surfaces of the rotor and one of the magnetic pole surfaces of the stator, which are in an identical spatial region, are arranged in an arbitrary order of an N pole and an S pole with respect to an order of magnetic pole surfaces appearing in one spatial region, except an arrangement of having a same-polarized pole and an alternate arrangement of the poles.
